(19) United States
(12) Patent Application Publication
(10) Pub. No.: US 2008/0069675 A1
(43) Pub. Date: Mar. 20, 2008

(54) Trunk loading apparatus for a wheelchair

(76) Inventor: Emmett Franklin Scism, Rural Hall, NC (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/522,620

(22) Filed: Sep. 18, 2006

(51) Int. Cl. B60P 9/00

(52) U.S. Cl. 414/462

(57) ABSTRACT

A vehicle trunk loading apparatus for a wheelchair is provided. The loading apparatus includes a base frame and a support platform. The base frame has a pair of substantially parallel, spaced apart ramp members, the ramp members inclining upwardly. The support platform is slideably movable atop the ramp members from a retracted stored position to a withdrawn loading position.

### FIELD OF THE INVENTION

The present invention relates generally to devices to facilitate loading of wheelchairs into a vehicle, and more particularly, to an apparatus for loading and storing a wheelchair in the trunk of an automobile.

### BACKGROUND OF THE INVENTION

For persons requiring the use of wheelchairs, or those who assist them, loading and unloading of the wheelchair into and out of an automobile can prove difficult, if not impossible. Where the wheelchair must be transported in the trunk of the automobile, this task is particularly problematic for persons who are aged or otherwise have limited upper body strength for lifting a folded wheelchair weighing almost fifty pounds over the lip of the trunk and back rear bumper of the vehicle.

While this problem and a number of devices and assemblies that are directed to the problem of loading and transporting wheelchairs are known in the art, these devices are bulky, heavy, mechanically and electrically complex, or otherwise difficult to manipulate. Additionally, the manipulation of these devices often results over time in damage to the vehicle, particularly the trunk and bumper areas.

The present invention is directed to a trunk loading apparatus for a wheelchair that addresses these problems.

### BRIEF DESCRIPTION OF THE DRAWINGS

FIG. 1 is a perspective view of one embodiment of the wheelchair trunk loading apparatus (without a wheelchair thereon) of the present invention in a stored position within the trunk of a vehicle;

FIG. 2 is a rear perspective view of the loading apparatus of FIG. 1 in the unloading position;

FIG. 3 is a side view of the loading apparatus of FIG. 1; and

FIG. 4 is a detail view of the hooking arrangement for the loading apparatus of FIG. 1.

### DESCRIPTION OF THE REFERRED EMBODIMENT

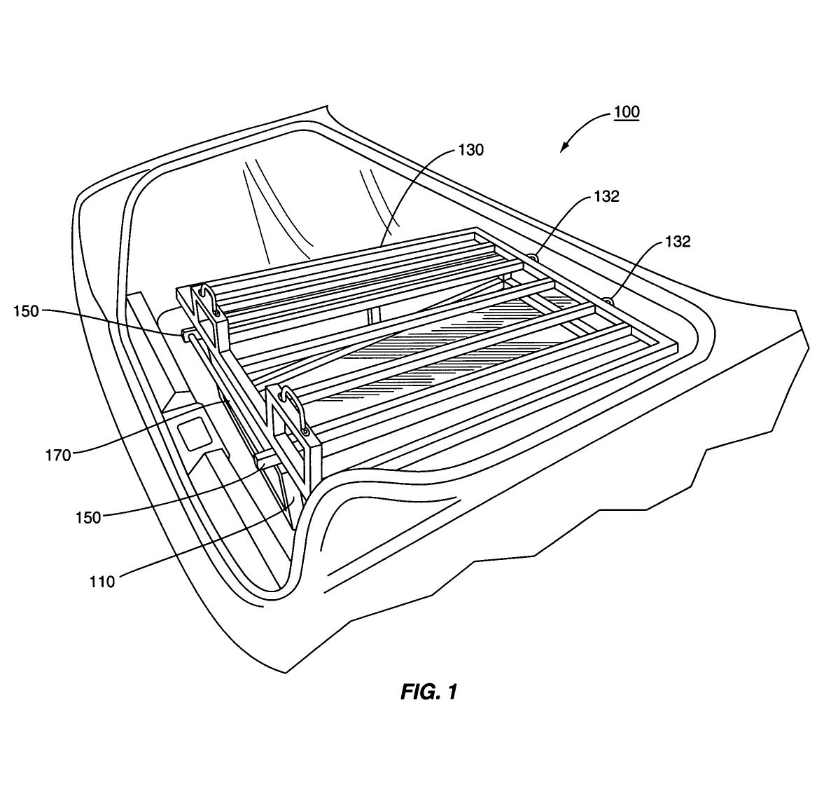

Referring to the Figures in general, the present invention is directed to trunk loading apparatus for a wheelchair, shown generally as 100. In its simplest construction, the trunk loading apparatus 100 comprises a base frame 110 and a wheelchair support platform 130. As shown in FIG. 1, in its stored position within the trunk of a vehicle, the base frame 110 supports the overlying support platform 130.

In one embodiment, the apparatus is constructed of spaced apart and interconnected lightweight tubular members that are welded together to provide sufficient structural rigidity, the present invention is not limited thereto. As those skilled in the materials and structural arts will appreciate, the apparatus 100 could be constructed or other rigid materials such as structural plastics, wood, etc. Further, the particularly arrangement and number of tubular members is not key to the invention so long as the apparatus can structurally support an average wheelchair weighing between about 45 and 50 pounds.

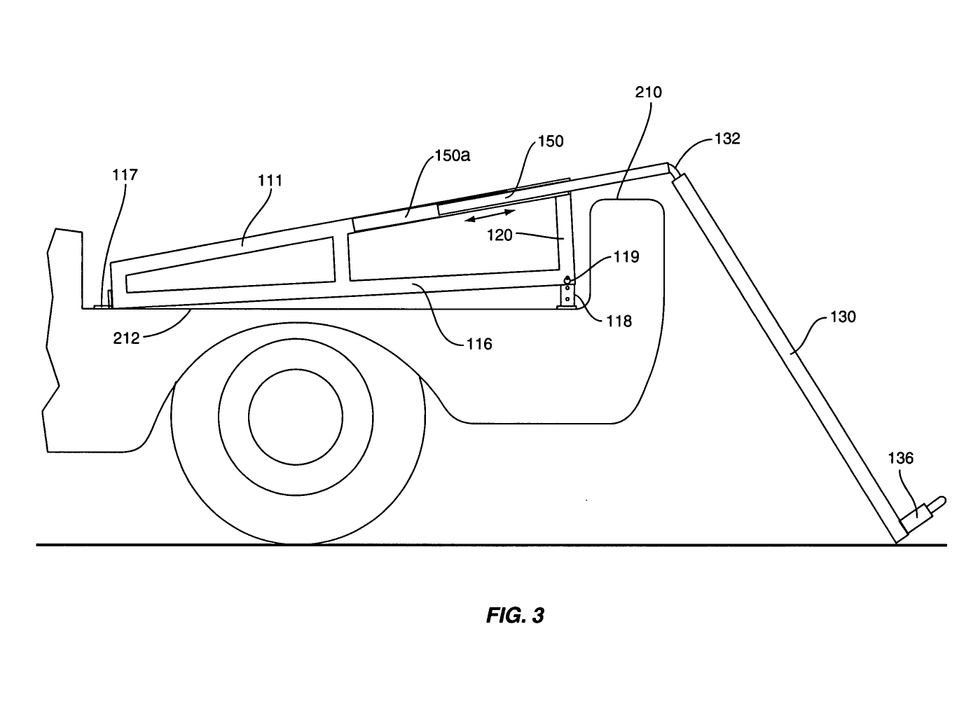

The base frame 110 includes and inner end 113 and an outer end 115 which provide structural support for a pair of substantially parallel, spaced apart ramp members 111. Unlike known prior art devices, and as best seen in FIG. 3, the ramp members 111 incline upwardly from the inner end 113 to the outer end 115 to facilitate sliding of the support platform 130 so that it clears the lip 210 of the vehicle when withdrawn to a loading/unloading position. This eliminates the need for a user to lift the support frame 130 when withdrawing it from the stored position. Since the depth of the trunk varies from one make of vehicle to another, optional vertically adjustable legs 118 are provided so that the outer end 115 of the base frame 110 can be raised or lowered as appropriate. In one embodiment, the adjustable legs 118 are tubular and are dimensioned so that they can slide upwardly and downwardly with the opposed vertical supports 120 located on either side of the outer end 115 of the base frame. As also shown in FIG. 3, the base frame 110 may further comprise lower, spaced apart supports 116 for the ramp members 111. To secure the base frame 110 within the trunk so it does not shift during transit or use, fasteners 117 at the inner end 113 are provided for attaching the base frame 110 to the floor 212 of the trunk. While numerous types of fasteners would be suitable, in the embodiment having optional vertically adjustable legs 118, the fasteners 117 are hinged.

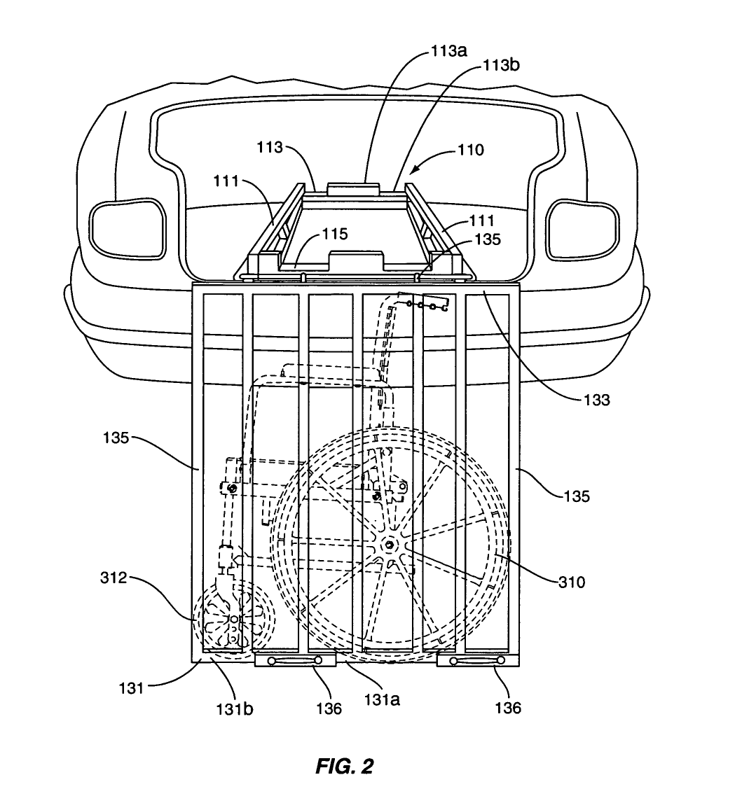

As best seen in FIG. 1, the wheelchair support platform 130 is slideably movable atop the ramp members 111 of the base frame 110. In the embodiment shown in the Figures, the support platform 130 is supported by the base frame 110, but not physically connected to the base frame by means of fasteners. A stop 113a at the inner end 113 of the base frame limits the rearward movement of the support platform 130 in the stored position. The support platform is also constructed of lightweight tubular aluminum members. The support frame comprises a front end 131 and a rear end 133. A series of spaced apart platform support members 135 connected at their ends by the front end 131 and rear end 133 members provide the structural support for the platform 130. As will be explained in greater detail below, spaced catches 132 are attached to the rear member 133 for engagement with a connecting member 170 when the support platform 130 is withdrawn. At least one, and as shown in the embodiment in FIG. 2, spaced apart handles 136 are attached to the front end 131 member of the support platform 130 to facilitate the withdrawal and lifting of the support platform 130 by a user. As shown the handles 136 are offset from the symmetry of the support platform 130 so provide spaces 131a, 131b for receiving the large 310 and small wheels 312, respectively of the wheelchair during loading and transit. These spaces further provide stability to the wheelchair to prevent shifting.

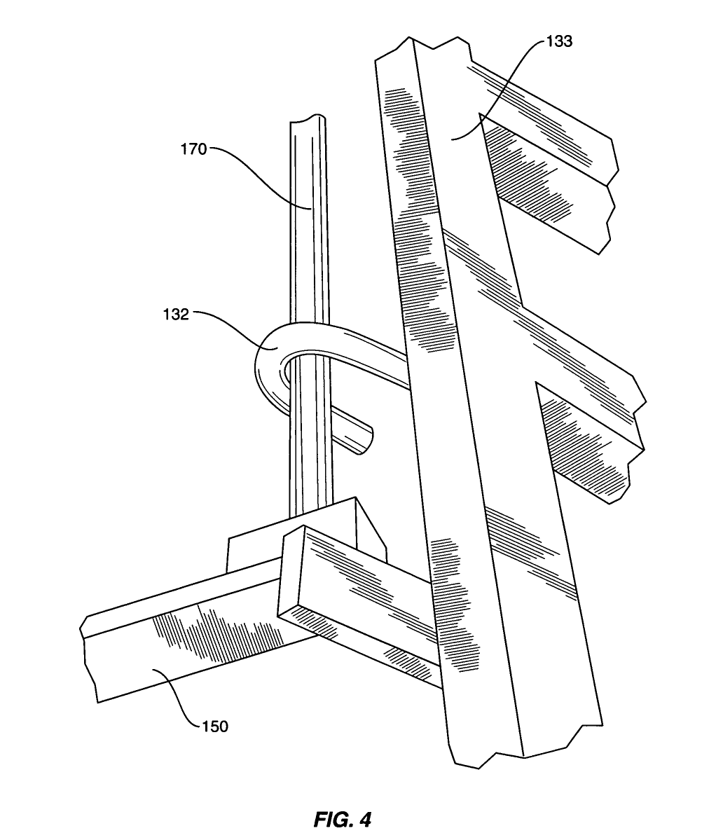

From a stored position, a user will grasp the handles 136 of the support platform and slideably withdraw the platform 130 upwardly on the ramp members 111. When the rear end 133 of the platform reaches the outer end 115 of the base frame, the spaced catches 132 engagement a rod, or connecting member 170. As best seen in FIG. 4, the catches are hooks 132. The connecting member 170 interconnects a pair of slides 150, each of the pair being mounted to an opposed ramp member 111. The slides 150 are extensible from guides 150a mounted on the sides of the ramp members 111 between a retracted stored position and a loading position extending outwardly beyond the outer end of the base frame 110. The slide 150 and guide 150a assembly may be constructed similar to conventional drawer or pocket door slide and guide assemblies.

Thus, as the user withdraws the support frame 130, the hooks 132 engage the connecting member 150 which pulls the slides 150 over the lip 210 of the vehicle trunk. As shown in FIG. 3, the extension of the slides 150 protects the lip 210 of the trunk and the rear bumper of the vehicle from damage during loading and unloading of the wheelchair.

To return the support platform 130 to a stored position, the user simply lifts upwardly on the handles 136 and slides the platform into the trunk. The weight and rearward movement of the platform 130 causes the slides 150 to retract into a stored position within the guides 150a. When returned to the stored position, the hooks 132 on the rear end 133 of the support platform 130 project through the openings 113b on either side of the stop 113a. This provides greater stability of the rear end 133 against the stop 113a during transit.

It should be recognized that the preferred embodiment described above is exemplary only. Certain modifications and improvements will occur to those skilled in the art upon a reading of the foregoing description. It should be understood that all such modifications and improvements have been deleted herein for the sake of conciseness and readability but are properly within the scope of the following claims.

I claim:

1. A vehicle trunk loading apparatus for a wheelchair, comprising:
(a) a base frame including an inner end, and an outer end, and a pair of substantially parallel, spaced apart ramp members, the ramp members inclining upwardly from the inner end to the outer end; and
(b) a support platform slideably movable atop the ramp members from a retracted stored position to a withdrawn loading position, the support platform having a front end and a rear end.

2. The loading apparatus of claim 1 further comprising:
(a) at least one catch member proximate the rear end of the support platform;
(c) a slide mounted to each ramp member, each slide extensible between a retracted stored position and a loading position extending outwardly beyond the outer end of the base frame; and
(d) a connecting member interconnecting the slides, the connecting member configured for engagement with the at least one catch member when the support platform is slideably withdrawn for loading or unloading a wheelchair.

3. The loading apparatus of claim 2 wherein the at least one catch member comprises at least two hooks for engaging the connecting rod, wherein when withdrawn the support platform is pivotal downwardly about the connecting member into to the loading position.

4. The loading apparatus of claim 1 further comprising at least one fastener at the inner end of the base frame for securing the base frame to the trunk.

5. The loading apparatus of claim 1 wherein the outer end of the base frame is vertically height adjustable.

6. The loading apparatus of claim 5 further comprising vertically adjustable legs.

7. The loading apparatus of claim 1 further including at least one handle proximate the front end of the support platform.
